(19) United States
(12) Patent Application Publication
(10) Pub. No.: US 2022/0065271 A1
(43) Pub. Date: Mar. 3, 2022

(54) Light-Driven Pneumatic Artificial Muscles/Soft Robots

(71) Applicant: Massachusetts Institute of Technology, Cambridge, MA (US)

(72) Inventors: Robert S. LANGER, Newton, MA (US); Seyed M. MIRVAKILI, Quincy, MA (US)

(21) Appl. No.: 17/463,030

(22) Filed: Aug. 31, 2021

Related U.S. Application Data
(60) Provisional application No. 63/073,113, filed on Sep. 1, 2020.

(51) Int. Cl. F15B 15/10

(52) U.S. Cl. CPC F15B 15/103; B25J 9/142

(57) ABSTRACT

Described herein is a method and apparatus for harnessing electromagnetic radiation for an untethered operation of an automaton. By employing a selective electromagnetic absorber film with a relatively low-boiling point fluid, an automaton can grasp and lift objects multiple times the mass of the fluid in a controllable fashion.

### BACKGROUND

Inspired by nature, researchers have developed soft robots that can perform complex robotic maneuvers, emulating biological systems, with their compliant structure. Unlike rigid robots, where only six degrees of freedom exist—due to the compliant structure of soft robots—they can offer an infinite number of degrees of freedom (e.g., torsion, bending, elongation, compression, wrinkling, buckling). This large number of degrees of freedom allows shape-invariant and pose-invariant grasping with simple control schemes.

To drive soft robots, muscle-like actuators (a.k.a., artificial muscles) have been employed in the form of tendon-like fiber actuators (e.g., shape memory alloys, nylon fibers) or fluid-driven actuators (e.g., pneumatic, hydraulic). Pneumatic actuators (a.k.a., pneumatic artificial muscles, or PAMs) generate strains and stresses very comparable to those of human skeletal muscles while exhibiting a simple actuation mechanism. One of the fundamental limitations of PAM-based soft robots is the size/weight requirement of valves, compressors, and pumps. Other mechanisms to generate the required pressure for actuation such as combustion, gas evolution reactions, chemically activating swelling/deswelling, and phase change materials have been explored. Except for phase-change materials, the rest of the described techniques are irreversible processes and cannot be used for the continuous and prolonged operation of the soft robots.

Heat, generated by various mechanisms (e.g., light, magnetic induction, or Joule heating), is the driving force for thermal actuators. Light-induced thermal actuation or photo-thermal actuation has been explored extensively with thermo-responsive polymers, liquid crystal elastomers, hydrogels doped with light-absorbing materials, and silicon micro-cantilevers for atomic force microscopy. While these materials offer some forms of actuation for small scale devices, none can be utilized to drive soft robots to perform untethered manipulation or locomotion at larger scales. Other types of non-thermal light-induced actuation mechanisms such as photostriction, cis-trans photoisomerization in azobenzenes, and photoreversible [2+2] cycloaddition reactions in polymers containing cinnamic groups exist. Nonetheless, they exhibit slow response time and small strain/stress not sufficient for realization in high performance soft robotic embodiments.

### SUMMARY

While untethered operation of soft materials with high power light, magnetic field, and electric field has been previously demonstrated. In accordance with the concepts described herein, it has been recognized that while electric and magnetic fields can be stimulants for untethered actuation, their rapid decay as a function of distance limits their efficacy for long-range operations.

Also, in accordance with the concepts described herein, in contrast to using electric and magnetic fields as stimulants, it has also been recognized that light in the form of sunlight or collimated from an artificial source does not decay rapidly, making it suitable for long-range excitation of untethered soft robots. Examples of artificial sources include, but are not limited to, lasers and Xenon (Xe) lamps.

Thus, in accordance with the concepts described herein, stimuli-responsive materials have been employed in soft robotics enabling new classes of robots that can emulate biological systems.

Described herein is an approach in harnessing sunlight for the untethered operation of soft robots. By employing a selective solar absorber film and a low-boiling point fluid (e.g., a fluid with a boiling point of about 34 degrees C.), light-operated soft robotic grippers grasping and lifting objects almost 25 times the mass of the fluid in a controllable fashion can be demonstrated. The results described herein demonstrate that the approach can possibly be implemented in the designs of untethered soft robots and even rigid robots for operation with light. The method described herein addresses one of the salient challenges in the field of untethered soft robotics. It precludes the use of bulky peripheral components (e.g., compressors, valves, or pressurized gas tank) and enables the untethered long-range operation of soft robots for performing important tasks such as grasping and lifting. Moreover, unlike other forms of light-driven actuators and soft robots which operate at elevated temperatures (e.g., temperatures greater than about 150° C.) (generated by infrared or ultraviolet), the device described herein operates at low to moderate temperature ranges (temperatures less than about 40° C.) under white light intensities making it safe for human interaction and exposure. Sunlight is ubiquitous in most part of the planet and the solar system enabling a wide range of applications for our design. It is anticipated that the method described herein can open a new direction in the field of untethered soft robotics and add unprecedented functionalities to soft robots in the macro and microscale.

In embodiments, a bladder or other means for generating mechanical work, may not be directly coupled to the gas chamber. For example, the pressure generated can be used for controlling and/or actuating other devices (e.g. other actuators, automatons, bladders). It should thus be appreciated that, in general, the concepts, systems, devices and techniques described herein are directed toward using EM waves (e.g., light or other EM waves) to generate gas pressure (i.e., pneumatic pressure) to generate mechanical work via hydraulic transfer of a force to an actuator (e.g. an actuator bladder or other types of actuator) or other device.

In accordance with an aspect of the concepts described herein, an actuator includes a vessel having a cavity and at least one opening and configured to hold a liquid; a liquid disposed within the vessel, the liquid having a boiling point less than or equal to 100 degrees Celsius (C) and a heat of vaporization less than 2257 kJ/kg; and a material disposed within the vessel and configured to absorb electromagnetic radiation and configured to vaporize the liquid in response to a temperature of the material substantially meeting or exceeding the heat of vaporization of the liquid.

In accordance with another aspect of the concepts described herein, the material substantially meets or exceeds the heat of vaporization in response to untethered absorption of electromagnetic radiation.

In accordance with another aspect of the concepts described herein, at least a portion of the vessel has a shape corresponding to one of: a cylinder; a sphere; a cone; a cube; a prism; and a pyramidal shape.

In accordance with another aspect of the concepts described herein, the liquid is one of: a non-cryogenic liquid; and a cryogenic liquid.

In accordance with another aspect of the concepts described herein, the material is configured to absorb electromagnetic radiation comprising at least one of: infrared light; laser light; a magnetic field; an electric field; a radio wave; a microwave; ultraviolet light; an X-ray; and a gamma ray.

In accordance with another aspect of the concepts described herein, the material comprises at least one of: a nanomaterial; a carbon nanotube; MXene; graphene; and Vantablack.

In accordance with another aspect of the concepts described herein, the actuator further includes a heat sink coupled to the vessel.

In accordance with another aspect of the concepts described herein, the actuator further includes at least one of: at least one automaton and at least one second actuator attached to the at least one opening in the vessel, respectively, wherein the at least one automaton and the at least one actuator are configured to exhibit at least one degree of motion upon vaporization of the liquid in the vessel.

In accordance with another aspect of the concepts described herein, the at least one automaton is a bladder that exhibits a degree of motion comprising at least one of: forward motion; backward motion; upward motion; downward motion; leftward motion; rightward motion; torsion motion; bending motion; elongation motion; compression motion; wrinkling motion; and buckling motion.

In accordance with another aspect of the concepts described herein, the actuator further includes at least one shaft in the at least one opening of the vessel, respectively.

In accordance with another aspect of the concepts described herein, the actuator further includes at least one automaton attached to the at least one shaft in the vessel, respectively, wherein the automaton is configured to exhibit at least one degree of motion upon vaporization of the liquid in the vessel.

In accordance with another aspect of the concepts described herein, the automaton is a bladder configured to exhibit a degree of motion comprising at least one of: forward motion; backward motion; upward motion; downward motion; leftward motion; rightward motion; torsion motion; bending motion; elongation motion; compression motion; wrinkling motion; and buckling motion.

In accordance with another aspect of the concepts described herein, the actuator further includes a rotator configured to rotate the vessel to control a temperature profile of the material and a pressure of vaporized liquid.

In accordance with another aspect of the concepts described herein, the rotator is coupled to one of the vessel and a light source.

In accordance with another aspect of the concepts described herein, the non-cryogenic liquid includes at least methyl perfluoropropyl ether; and the cryogenic liquid comprises at least one of: liquified argon gas; liquified oxygen gas; liquified helium gas; liquified hydrogen gas; liquified nitrogen gas; and liquified methane gas.

In accordance with another aspect of the concepts described herein, a method of actuation includes introducing a liquid into a vessel having at least one opening, wherein the liquid has a boiling point less than or equal to 100 degrees Celsius (C) and a heat of vaporization less than 2257 kJ/kg; introducing a material into the vessel configured to absorb electromagnetic radiation and configured to vaporize the liquid in response to a temperature of the material substantially meeting or exceeding the heat of vaporization of the liquid. due to untethered absorption of electromagnetic radiation; and exposing the material to electromagnetic radiation.

In accordance with another aspect of the concepts described herein, the method further includes: determining if a pressure in the vessel exceeds a threshold; in response to the pressure in the vessel exceeding the threshold, decreasing exposure/absorption to/of electromagnetic radiation and returning to determining the pressure in the vessel; in response the pressure in the vessel not exceeding the threshold, increasing the exposure/absorption of electromagnetic radiation and returning to determining the pressure in the vessel.

In accordance with a still further aspect of the concepts described herein, the method further includes: determining if a pressure in the vessel at a first orientation exceeds a first threshold; in response to the pressure in the vessel exceeding the first threshold, decreasing the absorption of electromagnetic radiation by performing one of rotating the vessel to a second orientation and decreasing a transparency of the vessel; determining if the vessel has one of the second orientation and the pressure in the vessel is less than a second threshold, wherein the second threshold is lower than the first threshold; in response to one of if the vessel has the second orientation and the pressure in the vessel is less than the second threshold; and if the pressure in the vessel is less than the second threshold, increasing the absorption of electromagnetic radiation by the material by performing one of rotating the vessel to the first orientation and increasing the transparency of the vessel; and returning to determining the pressure in the vessel.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1A is an illustration of an actuator and an automaton of an embodiment of the concepts described herein;

FIG. 1B is an illustration of a temperature change of the actuator of FIG. 1A;

FIG. 1C is an illustration of temperature dissipation in a heat sink of the actuator of FIG. 1A;

FIG. 1D is an illustration of an actuator of an embodiment of the;

FIG. 2 is a chart of an absorption spectrum of an electromagnetic absorber material of the actuator of FIG. 1D;

FIG. 3 is an illustration of an actuator, a pressure sensor, and a processing system of an embodiment of the concepts described herein;

FIG. 4A is a series of illustrations of an actuator and an automaton of an embodiment of the concepts described herein grasping and releasing an object;

FIG. 4B is a chart of temperature and pressure profiles of the actuator of FIG. 4A;

FIG. 4C is an illustration of an automaton of an embodiment of the concepts described herein in an inactivated state;

FIG. 4D is an illustration of the automaton of FIG. 4C in an activated state;

FIG. 5A is an illustration an actuator and an automaton of an embodiment of the concepts described herein being when an electromagnetic source is turned on;

FIG. 5B is an illustration of the actuator and the automaton of FIG. 5A when a pressure in the actuator exceeds a first threshold;

FIG. 5C is an illustration of the actuator and the automaton of FIG. 5B after the actuator is rotated and a pressure in the actuator falls below a second threshold;

FIG. 5D is an illustration of an automaton of an embodiment of the concepts described herein in an inactivated state;

FIG. 5E is an illustration of the automaton of FIG. 5D in an activated state;

FIG. 6A is an illustration of an automaton of an embodiment of the concepts described herein in an inactivated state;

FIG. 6B is an illustration of the automaton of FIG. 6B in an activated state; and

FIG. 7 is a flowchart of a method of operating an actuator in accordance with embodiments of the concepts described herein.

### DETAILED DESCRIPTION

One embodiment of the concepts described herein concerns a low-cost, highly functional, and easy-to-implement technique for driving an untethered automaton (e.g., a robot, a soft robot, a solar tracker, etc.). A method of the concepts described herein involves generating high-pressure gas via electromagnetic-energy induced evaporation of a low-boiling point (e.g., below 100 degrees Celsius (C)) liquid with a heat of vaporization (Hᵥ) less than 2257 kJ/kg (e.g., the Hᵥ of water) confined in a vessel or chamber. The electromagnetic energy includes infrared light (e.g., Sun light, lamp light, etc.), laser light, a magnetic field, an electric field, a radio wave, a microwave, ultraviolet light, an X-ray, a gamma ray, and any other suitable electromagnetic radiation. The liquid in the vessel may be a non-cryogenic liquid (e.g., a liquid at room temperature (e.g., 25 degrees C.)) or a cryogenic liquid (e.g., a liquid at a negative temperature but a gas at a higher temperature (e.g., room temperature)). Examples of cryogenic liquids include liquified Argon gas, liquified Helium gas, liquified Hydrogen gas, liquified Nitrogen gas, liquified Oxygen gas, liquified Methane gas, and any other suitable liquified gas. The relatively large volumetric expansion in the liquid-to-gas phase transition (e.g., 1600 for water at standard conditions) is harnessed to actuate an automaton (e.g., a soft robotic prototype) hydraulically. Thus, the actuator of the concepts described herein include an untethered hydraulic-pneumatic-actuator.

Untethered automaton grippers (e.g., a soft robot gripper, a McKibben-type artificial muscle gripper, etc.) may be used for grasping and lifting objects almost 25 times the mass of the phase-change fluid when exposed to white light. The concepts described herein may be implemented for a very low cost (e.g., $68 (USD) per unit). The concepts described herein may be downscaled easily for application in a miniature automaton (e.g., a miniature soft robot). Unlike electrical and pneumatic sources, sunlight is available in most parts of the planet and the solar system makes the concepts described herein widely applicable for a variety of applications.

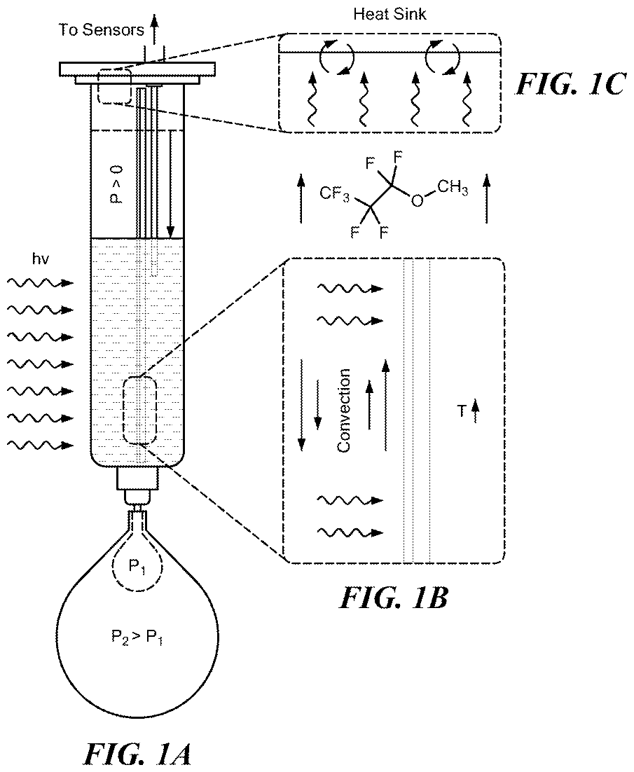

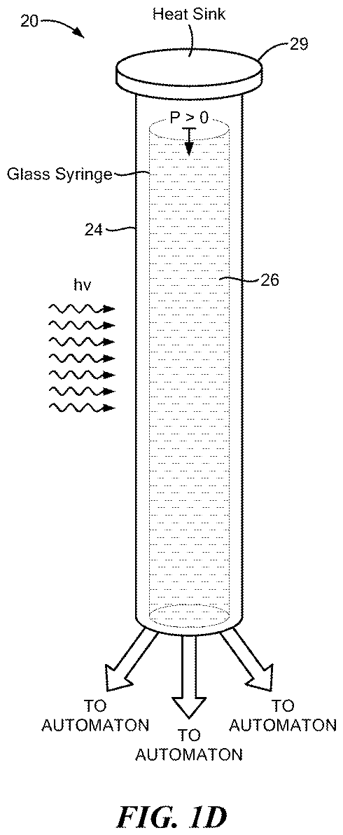

FIG. 1A is an illustration of an actuator 10 and an automaton 11 of an embodiment of the concepts described herein.

Referring to FIG. 1A, the actuator 10 includes a vessel 12, a material 13, a liquid 14, a heat sink 15, gas 16, and a sensor probe 17.

The vessel 12 includes a cavity to hold the liquid 14 and one opening. At least a portion of the vessel 12 may be any shape including, but not limited to, a cylinder; a sphere; a cone; a cube or rectangular box; a prism; and a pyramidal shape.

The liquid 14 has a boiling point less than or equal to 100 degrees Celsius (C) and a vaporization (Hᵥ) less than 2257 kJ/kg (e.g., the Hᵥ of water). The liquid 14 is one of a non-cryogenic liquid and a cryogenic liquid. The non-cryogenic liquid includes at least methyl perfluoropropyl ether; and the cryogenic liquid comprises at least one of: liquified argon gas; liquified oxygen gas; liquified helium gas; liquified hydrogen gas; liquified nitrogen gas; and liquified methane gas. The gas 16 in the vessel 12 results from the vaporization of the liquid 14.

The material 13 absorbs electromagnetic radiation to vaporize the liquid 14 in response to a temperature of the material 13 substantially meeting or exceeding the heat of vaporization of the liquid 14. The material 13 substantially meets or exceeds the heat of vaporization of the liquid 14 in response to untethered absorption of electromagnetic radiation. The material 13 absorbs electromagnetic radiation including, but not limited to, at least one of: infrared light; laser light; a magnetic field; an electric field; a radio wave; a microwave; ultraviolet light; an X-ray; and a gamma ray. The material 13 includes at least one of: a nanomaterial; a carbon nanotube; MXene; graphene; and Vantablack.

The heat sink 15 is coupled to the vessel 12 to dissipate heat from the vessel 12.

The automaton 12 is attached to the opening in the vessel 12. The automaton 12 exhibits at least one degree of motion upon vaporization of the liquid 14 in the vessel 12. In an embodiment, the automaton 12 is a bladder that exhibits a degree of motion including at least one of: forward motion; backward motion; upward motion; downward motion; leftward motion; rightward motion; torsion motion; bending motion; elongation motion; compression motion; wrinkling motion; and buckling motion.

In embodiments, a bladder or other means for generating mechanical work, may not be directly coupled to the vessel gas chamber. For example, the pressure generated can be used for controlling and/or actuating other devices (e.g. other actuators, automatons, bladders). It should thus be appreciated that, in general, the concepts, systems, devices and techniques described herein are directed toward using EM waves (e.g., light or other EM waves) to generate gas pressure (i.e., pneumatic pressure) to generate mechanical work via hydraulic transfer of a force to an actuator (e.g., an actuator bladder or other types of actuator) or other device.

In another embodiment, the actuator 10 includes a shaft in the opening of the vessel 12. The shaft is driven by the state of vaporization of the liquid 14 in the vessel 12, where the shaft operates the automaton 12 to exhibit at least one degree of motion upon vaporization of the liquid 14 in the vessel 12 as described above.

In another embodiment, the actuator 10 includes a rotator to rotate the vessel 12 to control a temperature profile of the material 13 and a pressure of the gas 16. The rotator is coupled to either the vessel 12 or a light source for providing electromagnetic radiation. The vessel 12 may be rotated about any axis (e.g., x, y, and z axes) through the vessel 12.

The sensor probe 17 senses at least temperature in the vessel 12. In an embodiment, the sensor probe 17 is remotely coupled to a processing system.

In an embodiment, the automaton 12 includes a soft robotic gripper with two fingers. In another embodiment, the automaton 12 includes a robotic arm.

FIG. 1B is an illustration of a temperature change of the actuator 10 of FIG. 1A.

Referring to FIG. 1B, as the material 13 absorbs electromagnetic radiation, the temperature of the liquid 14 rises. When the temperature of the liquid 14 substantially meets or exceeds the heat of vaporization of the liquid 14, the liquid 14 turns into a gas, where the gas then changes the state of an automaton as described above.

FIG. 1C is an illustration of temperature dissipation in the heat sink 15 of the actuator 10 of FIG. 1A.

Referring to FIG. 1C, the heat sink 15 absorbs heat from the vessel 12.

FIG. 1D is an illustration of a actuator 20 of an embodiment of the concepts described herein.

Referring to FIG. 1D, the actuator 20 includes a vessel 24, a material 26, a liquid 28, and a heat sink 29.

The vessel 24 has all of the attributes of the vessel 12 of FIG. 1A described above but with multiple openings 25. The vessel 24 includes a cavity to hold the liquid 28 and at least one opening 25. At least a portion of the vessel 24 may be any shape including, but not limited to, a cylinder; a sphere; a cone; a cube or rectangular box; a prism; and a pyramidal shape. However, any other suitable shape now known or developed in the future may be used in the concepts described herein.

The liquid 28 has all of the attributes of the liquid 14 of FIG. 1A described above. A gas in the vessel 24 results from the vaporization of the liquid 28.

The material 26 has all of the attributes of the material 13 of FIG. 1A described above.

The heat sink 29 is coupled to the vessel 24 to dissipate heat from the vessel 24.

At least one automaton is attached to the at least one opening 25 in the vessel 24. The at least one automaton has all of the attributes of the automaton 12 of FIG. 1A described above.

In another embodiment, the actuator 20 includes at least one shaft in the at least one opening 25 of the vessel 24. The at least one shaft is driven by the state of vaporization of the liquid 28 in the vessel 24, where the at least one shaft operates at least one automaton to exhibit at least one degree of motion upon vaporization of the liquid 28 in the vessel 24 as described above.

In another embodiment, the actuator 20 includes a rotator to rotate the vessel 24 to control a temperature profile of the material 26 and a pressure of vaporized liquid 28. The rotator is coupled to one of the vessel 24 and a light source for providing electromagnetic radiation.

An embodiment of the concepts described herein includes at least: a pressure chamber (e.g., a vessel) containing a low-boiling point liquid (e.g., 34 degrees C. at 1 atmosphere (atm) with a low heat of vaporization (e.g., less than 2257 kJ/kg) and a material (e.g., a solar absorber film). In an embodiment, an automaton may be made of compliant silicone rubber. The pressure chamber may be any shape (e.g., a cylinder, a rectangular box, a sphere, a cone, a cube, a prism, a pyramidal shape, and any other suitable shape now known or developed in the future). In an embodiment, the pressure chamber may be a glass syringe with one end sealed and the other end connected to an automaton (e.g., a soft robot). In another embodiment, the pressure chamber may include a heat sink to rapidly reduce the temperature of the pressure chamber and, thus, reverse the vaporization process to return the contents of the pressure chamber to a liquid state. The heat sink may be at least one piece of metal (e.g., a piece of metal at one end of the pressure chamber, multiple metallic fins extending from the pressure chamber, etc.). However, the concepts described herein are not limited to a glass syringe pressure chamber or a pressure chamber having only one opening. The pressure chamber may include more than one opening. To accelerate the evaporation of a low-boiling point liquid with a low heat of vaporization under electromagnetic (e.g., infrared light) irradiation, a commercially available selective solar absorber film may be used. Solar absorber films convert sunlight to heat with conversion efficiencies of more than 95% in the visible range. Nanomaterials such as carbon nanotubes (25, 26), MXenes (27), and graphene (28) offer better conversion efficiencies—more than 99% for Vantablack.

When exposed to a sufficiently high-intensity infrared light (e.g., white light), the solar absorber film heats the fluid in the pressure chamber, which significantly increases its vapor pressure and, thus, its evaporation. However, as the fluid and the pressure chamber heat up above the ambient temperature, heat losses to the environment may occur, which reduces the temperature rising rate in the pressure chamber. These heat losses are, however, necessary for a fast relaxation (cooldown of the fluid and, thus, drop in pressure) of the automaton (e.g., soft robot) from the excited state. Optimization of the solar heat gains and heat loss mechanisms, therefore, play a role in increasing the actuation rate.

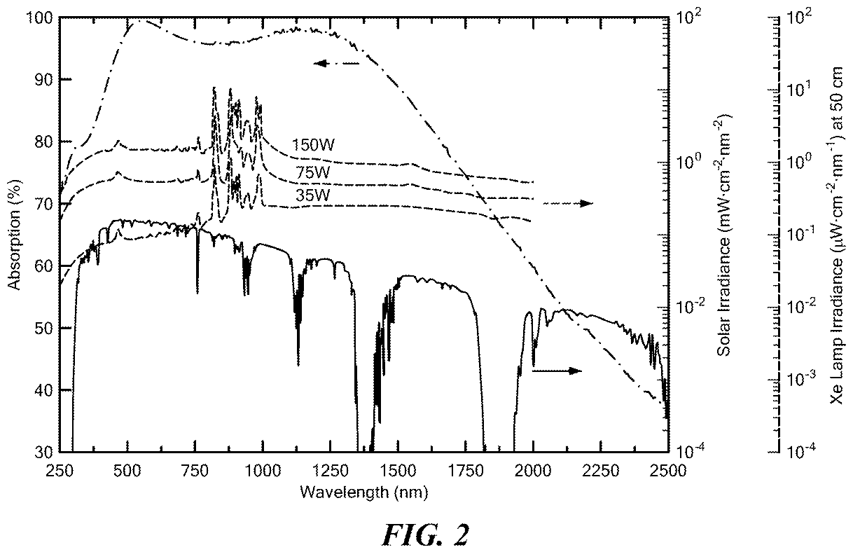

FIG. 2 is a chart of an absorption spectrum of an electromagnetic absorber material of the actuator of FIG. 1D;

Referring to FIG. 2, an absorption spectrum of a selective solar absorber film is illustrated. Spectral power density for the solar radiation an Xe lamps with an input power of 35 Watts (W), 75 W, and 150 W are illustrated.

Instead of sunlight, light from a Xenon (Xe) lamp (e.g., 55 Watts (W)) may be directed toward the solar light absorber. From the spectral irradiance profile, the irradiance of a Xe lamp is approximately 6.85 W/m² at 50 cm. To achieve a higher intensity, a reflector may be used to irradiate more than approximately 4 kW/m². Sunlight outdoors has an estimated power of 1±0.2 kW/m².

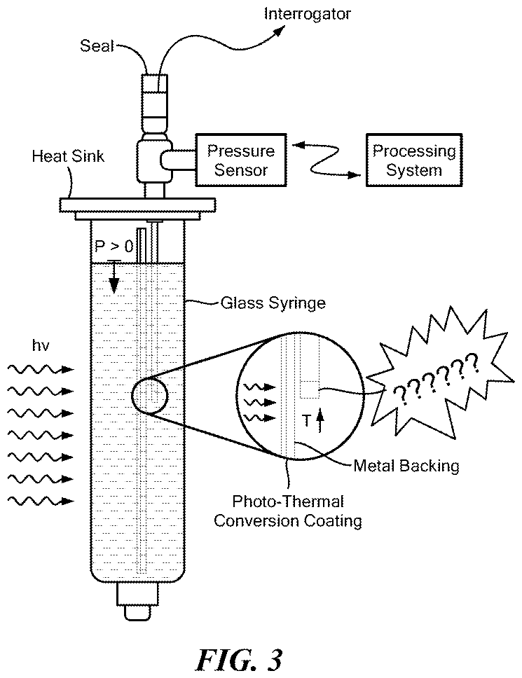

FIG. 3 is an illustration of an actuator 30, a pressure sensor 37, and a processing system 38 of an embodiment of the concepts described herein.

Referring to FIG. 3, the actuator 30 includes a vessel 31, a material 32, a liquid 33, a heat sink 34, gas 35, and a temperature sensor probe 36.

The vessel 31 has the same attributes as the vessel 12 of FIG. 1A described above.

The liquid 33 has the same attributes as the liquid 14 of FIG. 1A described above. The gas 35 in the vessel 31 results from the vaporization of the liquid 33.

The material 32 has the same attributes as the material 13 in FIG. 1A described above.

The heat sink 34 is coupled to the vessel 31 to dissipate heat from the vessel 31.

In another embodiment, the actuator 30 includes a shaft in the opening of the vessel 31. The shaft is driven by the state of vaporization of the liquid 33 in the vessel 31, where the shaft operates an automaton to exhibit at least one degree of motion upon vaporization of the liquid 33 in the vessel 31 as described above.

In another embodiment, the actuator 30 includes a rotator to rotate the vessel 31 to control a temperature profile of the material 32 and a pressure of the gas 35. The rotator is coupled to either the vessel 31 or a light source for providing electromagnetic radiation.

The temperature sensor probe 36 senses temperature in the vessel 31. The temperature sensor probe 36 is remotely coupled to the processing system 38.

The pressure sensor 37 is coupled to the actuator 30 and senses pressure of the gas 35 in the vessel 31. The pressure sensor 37 is remotely coupled to the processing system 38.

A 1D analytical model may be used to understand the concepts described herein and evaluate the influence of system parameters. The 1D model may be used to estimate the time-dependent temperature and pressure of the chamber or vessel as a function of the input light flux. The model couples the first law of thermodynamic around the chamber with the ideal gas law in the vapor gap, and conservation of mass to the fluid inside the chamber to solve for the system's three unknowns—system's temperature T, the mass of fluid in the liquid (mf) and gaseous (m_{g}) state. The 1D model was validated with a 3D COMSOL model of the system. While numerical simulation predicts the system more accurately by accounting for natural convection and temperature gradients within the fluid and gas, it is computationally intensive and takes longer (hours vs. seconds) to converge compared to the analytical model. Thus, the 1D analytical model may be used to study the system.

Sensible heating accounts for approximately 65.9% of the total energy received by an absorber film. The sensible heating includes heating of the fluid, the condenser (i.e., a heat sink), the chamber, and the absorber film. Sensible heating of the chamber is almost equal to that of the fluid, both accounting for most of the absorbed solar flux. The heat capacity of the system, in this case, dominated by the fluid and the chamber, plays a significant role in determining how fast the system can heat up and cool down. Decreasing the mass or specific heat of the fluid or the chamber could significantly help to reduce the heating and cooling time for faster actuation times. Acrylic is transparent and machinable but possesses specific heat capacity higher than that of glass (2.16 J/g·K vs. 0.83 J/g·K). Reducing the thickness of a glass chamber (e.g., a syringe) wall can help to minimize the chamber sensible heating. Other losses, such as convection, radiation, and optical losses (e.g., glass transmittance), account for approximately 16.57%, 6.84%, and 10.76% of the total energy balance, respectively. Thermal losses are necessary to achieve fast cooling and, thus, actuation of the device. Increasing the effective heat transfer coefficient with the ambient using radiative cooling or extended surfaces (e.g., fins) can be used at the expense of higher heat losses during heating and increased thermal mass.

Evaporation energy may account for only approximately 0.014% of the total energy. This small portion corresponds to the small evaporated mass of the fluid (e.g., ˜1.5 mg), which is limited by the temperature-dependent vapor pressure of the liquid and the free volume at the top of the chamber.

A similar closed-system can be exposed to sunlight (e.g., 630 W/m²) in a closed environment (e.g., indoor-behind windows). Unlike excitation with a Xe lamp, conditions such as ambient temperature and light intensity (e.g., clouds covering the Sun) may fluctuate.

A peak pressure (e.g., 85 kPa) generated in the closed-system is enough to actuate automatons (e.g., robotic arms and linear pneumatic air cylinders) to lift objects as heavy as 0.5 kg, 25 times the mass of the fluid in the chamber. The required pressure for grasping objects like an 86 g tomato is almost double than that for lifting a 642 g soda can (including the barrel and the plate). This disproportionality can be explained by the fact that the friction force for grasping an object is proportional to the normal force and the coefficient of friction. Therefore, the more slippery or smaller the coefficient of the friction at the surface of an object is, the higher the normal force needs to be to grasp on that object. With the peak pressure measured, in a hydraulic configuration, an automaton can be expected to lift a 1.3 kg object with only 15 mL of the phase-change fluid. More prolonged light exposure can lead to higher pressures, thus, higher output forces.

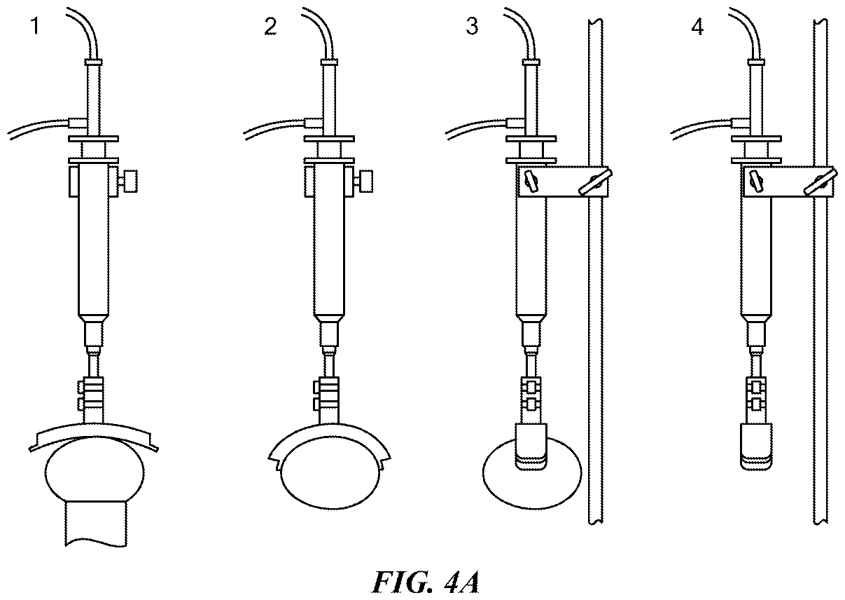

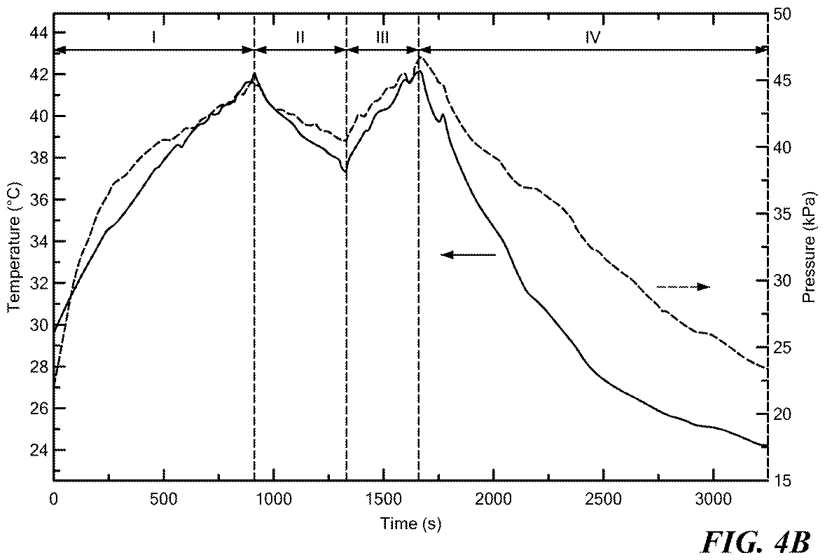

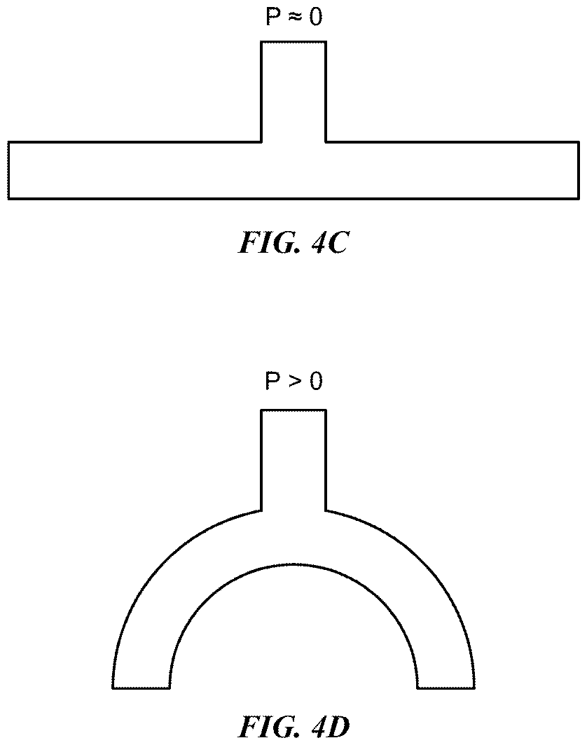

FIG. 4A is a series of illustrations of an actuator and an automaton of an embodiment of the concepts described herein grasping and releasing an object.

FIG. 4B is a chart of temperature and pressure profiles of the actuator of FIG. 4A.

Referring to FIGS. 4A and 4B, direct sunlight may be directed toward a pressure chamber or vessel of the actuator. Due to fluctuations in environmental conditions, the temperature and pressure profiles of the pressure chamber may not be as smooth as when light from a Xe lamp is directed toward the pressure chamber. Clouds can reduce solar irradiance by up to 80%. The reduction in solar irradiance can increase the actuation period.

The first through fourth panels of FIG. 4A correspond to sections I, II, III, and IV in the chart of FIG. 4B, respectively.

In the first two panels of FIG. 4A, under direct sunlight (e.g., 1 kW/m²), the automaton (e.g., a soft robotic gripper) grasps a 56 g boiled egg. To prevent the bursting of the soft robotic gripper, the pressure chamber (e.g., a glass syringe) may be rotated a number of degrees (e.g., 90°), as illustrated in the third and fourth panels of FIG. 4A, to reduce the temperature of the pressure chamber and, therefore, the pressure in the pressure chamber. For example, when the pressure in the pressure chamber reaches about 45 kPa, as illustrated in FIG. 4B, the pressure chamber may be rotated to cool down the pressure chamber. The pressure chamber cools down, because rotating the pressure chamber reduces the solar absorption at the absorber. In another embodiment, instead of rotating the pressure chamber, an angle of the light directed toward the pressure chamber may be rotated. The pressure chamber (e.g., syringe) may be rotated back to its initial angular position when the pressure reaches approximately 40 kPa. At a final stage, the pressure chamber (e.g., syringe) is cooled down at the 90° angular position. With an automaton (e.g., a robotic arm) excited with a Xe lamp with 1.8 kW/m² light intensity, the automaton may hold a 40 g tape roll during the excitation cycle. The automaton (e.g., a robotic gripper) is capable of shape-invariant grasping. However, for large radius ring-shaped items that are too large for one type of automaton (e.g., a soft robotic gripper), another type of automaton (e.g., a robotic arm) may perform better. In another embodiment, the transparency of the pressure chamber may be changed to change the pressure in the pressure chamber. For example, the pressure chamber may include a liquid crystal whose transparency may be changed remotely.

Pieces of soft robots may be fabricated through a molding process. For example, a soft robotic gripper and a robotic arm may be 3D printed with a fused deposition modeling 3D printer (e.g., FlashForge Creator Pro) with a Polylactic acid thermoset filament (e.g., 1.75 mm in diameter) and layer and print resolutions of 0.1 mm and 0.2 mm, respectively. EcoFlex 00-50 platinum-catalyzed silicone rubber may be used to fabricate parts of a soft robot. A one-to-one ratio of the two precursors for EcoFlex 00-50 may be mixed and then degassed in a desiccator for 5 minutes with a rotary vacuum pump. After filling the molds with the mixture, the mixture may be degassed further and cured at the room temperature for 4 hours. A piece of cotton fabric may be adhered to a gripping side of a soft robot by coating the fabric with EcoFlex 00-50. This may create an anisotropic expansion of the soft robot upon excitation to produce bending.

For agile soft robots, the actuation response time may be a rate-limiting factor. Boiling point and excitation irradiation are two parameters in determining the actuation time response for an embodiment of the concepts described herein. The concepts described herein may use liquids as the fluid in the pressure chamber that are liquids at positive temperatures (e.g., non-cryogenic liquids) or liquids that are liquids at negative temperatures but gasses at higher temperatures (e.g., cryogenic liquids). Non-cryogenic fluids may be used in environments in which humans may function without the need for any special protection, whereas cryogenic fluids may be used in environments in which humans may not be able to function without special protection (e.g., extremely cold environments, space applications, etc.). A non-cryogenic chemically inert engineered fluid (i.e., Methyl perfluoropropyl ether) with a boiling point of 34° C. may be used as the fluid in the pressure chamber to achieve a relatively fast actuation rate. Compared to water, the engineered fluid requires 27 times smaller heat per mass to reach the boiling point (1 atm vapor pressure) (from 25° C.). Similarly, it has a latent heat of evaporation 16 times lower than that of water. Examples of cryogenic fluids include liquified Argon gas, liquified Helium gas, liquified Hydrogen gas, liquified Nitrogen gas, liquified Oxygen gas, liquified Methane gas, and any other suitable liquified gas.

Downscaling can enhance the actuation rate but at the expense of undermining the useful output force and degrees of freedom. For a pneumatic architecture, the pressure can be increased with more vapor or with higher temperatures. However, in a hybrid hydraulic-pneumatic architecture, a portion of the fluid volume contributes to actuating an automaton (e.g., a soft robotic gripper) and, thus, determines a minimum required volume of fluid for operation. For small scale applications where a small range of forces is needed, scaling can be advantageous.

Control is an element in soft robotics. For tethered actuators, electrical power or pneumatic pressure is controlled directly by a closed-loop circuit. In contrast, for untethered phase-change pneumatic actuators and soft robots, the pressure is developed in response to an external stimulus. Therefore, controlling the pressure or volume is vital to prevent the bursting of the soft robot. In an embodiment of the concepts described herein, a low-level control scheme in the actuation space may be implemented.

FIG. 4C is an illustration of an automaton 40 of an embodiment of the concepts described herein in an inactivated state. FIG. 4D is an illustration of the automaton 40 of FIG. 4C in an activated state.

Referring to FIGS. 4C and 4D, the automaton 40 is straight and perpendicular to a pressure inlet valve 42 when an insufficient amount of pressure (e.g., pressure is approximately 0) is supplied to the automaton 40 by an actuator. The pressure inlet valve 42 bisects the straight portion of the automaton 40. Both ends of the straight portion of the automaton 40 curve when a sufficient amount of pressure (e.g., pressure greater than 0) is supplied to the automaton 40 by the actuator. The curve of both ends of the straight portion of the automaton 40 enables the automaton 40 to grasp and hold an object.

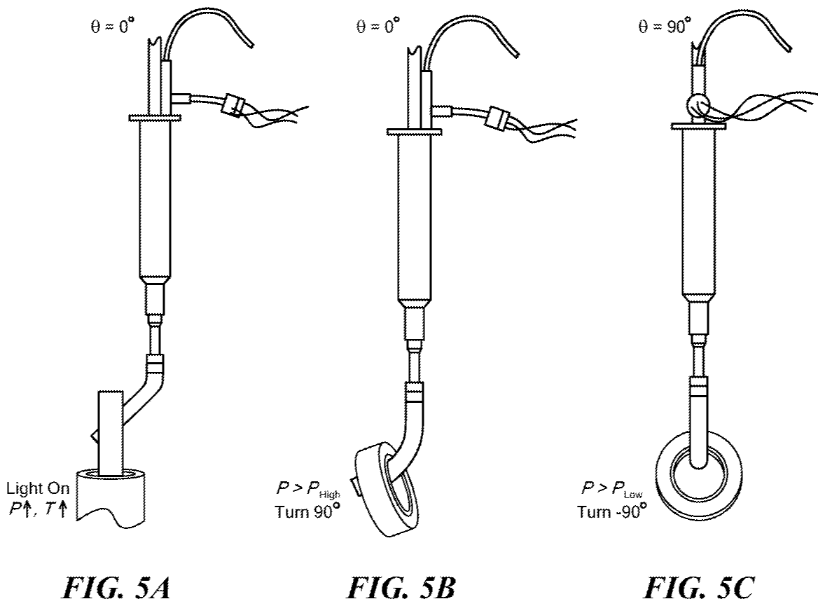

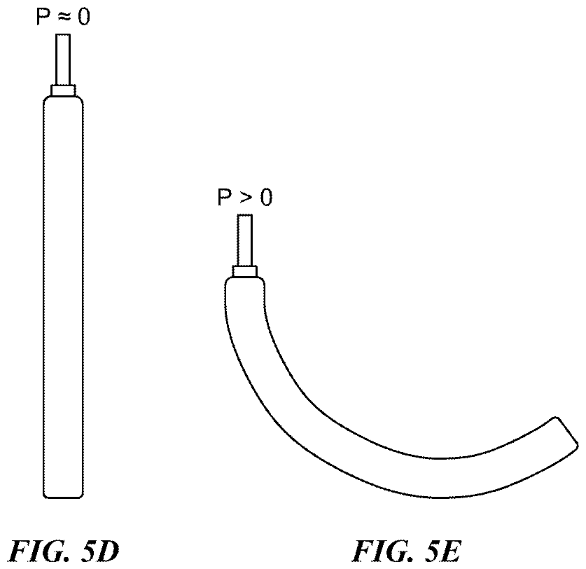

FIG. 5A is an illustration an actuator 50 and an automaton 52 of an embodiment of the concepts described herein being when an electromagnetic source is turned on. FIG. 5B is an illustration of the actuator 50 and the automaton 52 of FIG. 5A when a pressure in the actuator 50 exceeds a first threshold. FIG. 5C is an illustration of the actuator 50 and the automaton 52 of FIG. 5B after the actuator is rotated and a pressure in the actuator 50 falls below a second threshold.

Referring to FIGS. 5A, 5B, and 5C, temperature and pressure of a system are functions of an incident angle of light on a light-absorber film in the actuator 50. By exploiting this relationship, a control scheme to converge to a desired pressure may be achieved by monitoring the pressure and modulating the incident angle (by rotating a pressure chamber (e.g., a glass syringe) of the actuator 50 or rotating the light source). The pressure chamber may be rotated about any axes of the actuator 50. Other proprioceptive sensors with alternative control schemes may be used to operate the automaton 52 (e.g., a soft robot) smoothly. However, modulating the irradiation absorption precludes the use of exotic elements such as electrochromic films. Moreover, unlike shading—which is a binary effect—changing the angular position of the pressure chamber (e.g., syringe) offers a continuous spectrum of pressure/temperature values.

Rotating the pressure chamber (e.g., a glass syringe) of the actuator 50 or the light source by an angle (e.g., 90°) offers a drop in the temperature/pressure of the pressure chamber (e.g., an angle rotation of 90° may offer the largest drop in the temperature/pressure). The pressure chamber of the actuator 50 may be rotated by any angle about any axes of the pressure chamber. The temperature/pressure slightly increases when the angle of rotation is above 90°, which is due to an increase in the exposed area of the film to the irradiation. At an angular position of 90°, light absorption by the pressure chamber (e.g., a glass syringe) prevents a complete relaxation to room temperature. Thus, making it faster to reach the peak temperature and pressure in the next excitation cycle. This energy-saving mechanism may be advantageous for rapid “pick-and-place” maneuvers.

In an embodiment, a microcontroller is used in a control scheme to continuously monitor the pressure in the pressure chamber. The monitoring may be done remotely.

In FIG. 5A, the actuator 50 is oriented at an angle of 0 degrees. When a light source is turned on, the pressure and temperature in the actuator 50 rise, causing the automaton 52 to curve upward and pick up an object 54 (e.g., a roll of tape) by hooking the object 54 onto the automaton 52.

In FIG. 5B, when the pressure reaches an upper threshold (e.g., P_{high}), the microcontroller commands a stepper motor to start to rotate the pressure chamber (e.g., a glass syringe) of the actuator 50 from the 0 degree angle by an angle (e.g., 90°).

In FIG. 5C, the stepper motor finishes rotating the pressure chamber (e.g., a glass syringe) of the actuator 50 to the user-definable angle (e.g., 90°). Then, the temperature and pressure decrease until pressure reaches a lower threshold (e.g., P_{low}). At this point, the stepper motor rotates the pressure chamber (e.g., a glass syringe) back to its initial angular position in FIG. 5A. Therefore, the pressure may oscillate between P_{high} and P_{low}. Using this control scheme, the internal pressure of an automaton (e.g., a robotic arm) may be controlled within only 1 kPa range. The automaton may hold a tape roll for more than 200 s without collapsing. In another embodiment, when the pressure reaches an upper threshold (e.g., P_{high}), the microcontroller commands a stepper motor to rotate the light source by an angle (e.g., 90°) to change the angle of the light incident upon the pressure chamber. In another embodiment, the pressure chamber is electrochromic glass. When the pressure in the electrochromic glass pressure chamber reaches an upper threshold (e.g., P_{high}), a microcontroller commands a voltage to be applied across the electrochromic glass pressure chamber to decrease the transparency of the pressure chamber and, thus, decrease the pressure in the pressure chamber. One type of electrochromic glass employs liquid crystals which are aligned under an electric field.

Due to the untethered nature of the concepts described herein and the output force an automaton can generate, the concepts described herein may be employed in a variety of real-world applications (e.g., solar tracker applications on Earth or in space). Aside from soft robotics, solar cells may also make use of the actuator of the concepts described herein. Solar cells best absorb the sunlight when the solar irradiation is at a specific angle with the surface of the solar cells (e.g., panels). Due to the Earth's rotation or the rotation of solar panels in space, the incident angle changes from the sunrise to the sunset. Thus, the solar panels may be rotated or tilted by the concepts described herein to maintain optimal alignment with the Sun or any other celestial body that emits electromagnetic radiation. Currently, active solar trackers are mainly used to maintain the incident angle. Considering that the trackers consume energy to keep the incident angle constant, it is more efficient to utilize technologies that can achieve solar tracking passively. The sunlight or even the waste heat generated by solar cells can be harnessed to power up the actuator. Considering the slow actuation rate of the actuator, it may be very well suited for solar tracking applications. In another application, the concepts described herein may be used for space exploration applications by harnessing the ubiquitous light in the solar system.

An embodiment of the concepts described herein is a low-cost, and highly functional actuator for driving an automaton (e.g., a soft robot) with light. The concepts described herein offers long-range excitation of an automaton (e.g., a soft robot) with collimated light or sunlight, enabling its application in places where electrical or pneumatic sources are not available. With two different soft robots and a low-level control scheme, the concepts described herein may lift and grasp an object used in daily life. These capabilities suggest new possibilities for applications for different types of automatons (e.g., soft robots and rigid robots). Furthermore, the concepts described herein may be implemented in different scales (e.g., from nano to macro) in which implementing tethered automatons (e.g., soft robots) is impossible.

In an embodiment, the body of the pressure chamber (e.g., glass) may be fabricated from a 10 mL borosilicate glass metal Luer Lock syringe. After cleaning the inner surfaces of the pressure chamber (e.g., a glass syringe) with 70% ethyl alcohol, a 14 mm×88 mm piece of solar absorber film (Eta Plus® AL) with a thickness of 0.4 mm may be placed in the center of the pressure chamber (e.g., syringe). A top end of the pressure chamber (e.g., syringe) may be sealed with a metallic film (e.g., a heat sink) with a thickness of 1.9 mm and a diameter of 29.3 mm. A barbed tee connector (for ⅛″ tube inner diameter (ID)) may be used to incorporate the temperature sensor fiber to the pressure chamber. A Luer Lock syringe tip cap may be locked to a needle adapter to seal a syringe completely. For integration with soft robots, a blunt tip needle (15G-1.8 mm tip diameter) may be used to connect a syringe to an automaton (e.g., a soft robots). The connection point may be reinforced with a zip tie.

FIG. 5D is an illustration of an automaton 50 of an embodiment of the concepts described herein in an inactivated state. FIG. 5E is an illustration of the automaton 50 of FIG. 5D in an activated state.

Referring to FIGS. 5D and 5E, the automaton 50 is straight and in line with a pressure inlet valve 52 when an insufficient amount of pressure (e.g., pressure is approximately 0) is supplied to the automaton 50 by an actuator. The pressure inlet valve 52 is located at one end of the automaton 50. The other end of the automaton 50 that does not contain the pressure inlet value 52 curves when a sufficient amount of pressure (e.g., pressure greater than 0) is supplied to the automaton 50 by the actuator. The curve of one end of the automaton 50 enables the automaton 50 to hook onto an object.

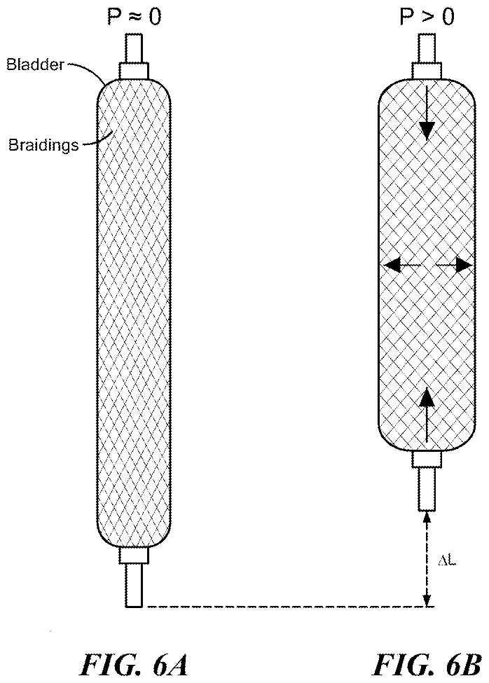

FIG. 6A is an illustration of an automaton 60 of an embodiment of the concepts described herein in an inactivated state. FIG. 6B is an illustration of the automaton 60 of FIG. 6B in an activated state.

Referring to FIGS. 6A and 6B, the automaton 60 is straight and in line with a pressure inlet valve 62 when an insufficient amount of pressure (e.g., pressure is approximately 0) is supplied to the automaton 60 by an actuator. The pressure inlet valve 62 is located at one end of the automaton 60. The automaton 60 expands when a sufficient amount of pressure (e.g., pressure greater than 0) is supplied to the automaton 60 by the actuator. The expansion of the automaton 60 enables the automaton 60 to act as an artificial muscle.

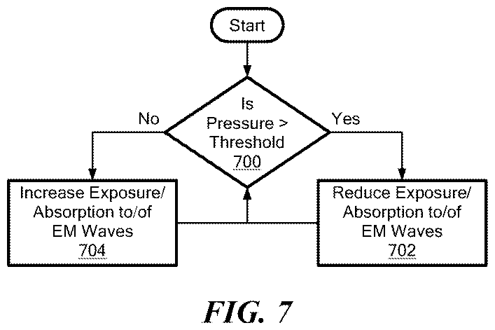

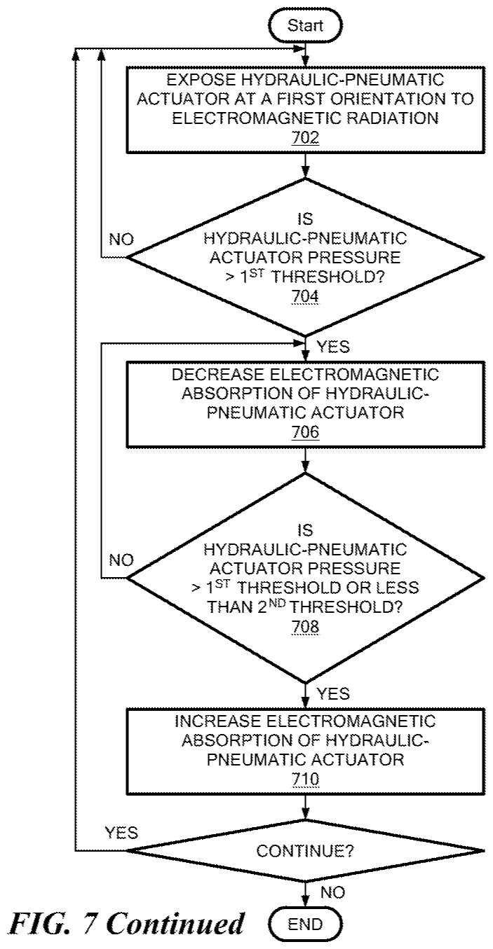

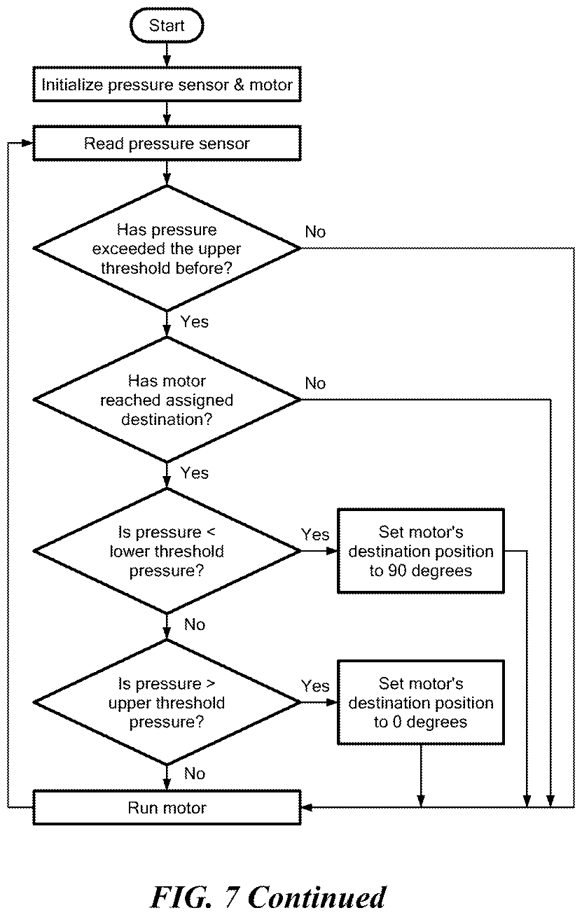

FIG. 7 is a flow diagram showing illustrative processing that can be implemented within an actuator system (e.g. any of the exemplary systems illustrated in FIGS. 1-6B). Rectangular elements (typified by element 702 in FIG. 7), denoted as “processing blocks,” represent computer software instructions or groups of instructions. Diamond shaped elements (typified by element 700 in FIG. 7), denoted as “decision blocks,” represent computer software instructions, or groups of instructions, which affect the execution of the computer software instructions represented by the processing blocks. Alternatively, the processing and decision blocks may represent processes performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated, the particular sequence of blocks described is illustrative only and can be varied without departing from the spirit of the concepts, structures, and techniques described. Thus, unless otherwise stated the blocks described below are unordered meaning that, when possible, the functions represented by the blocks can be performed in any convenient or desirable order.

Turning now to FIG. 7, an actuator, at a first orientation is exposed to electromagnetic radiation (e.g., a light source) as described above. In response to such exposure, a temperature and a pressure in the actuator start to rise due the absorption of the electromagnetic radiation by a material in the actuator, which causes a liquid in the actuator to vaporize.

In decision block 700, a determination is made as to whether the pressure in the actuator is greater than a threshold pressure (e.g., which in some embodiments may be referred to as an upper threshold). The threshold may be a pressure at which the actuator reaches a first activation limit of an automaton (e.g., an upper limit for grasping an object).

When the pressure in the actuator is greater than the threshold pressure, processing proceeds to block 702 in which electromagnetic exposure/absorption in the actuator is reduced or decreased. A decrease in the electromagnetic exposure/absorption of the actuator may be achieved using a variety of techniques. For example, a decrease in the exposure/absorption to/of electromagnetic (EM) waves by the actuator may be achieved by moving (e.g. rotating or otherwise moving) the actuator to a second different orientation. For example, if the first orientation of the actuator is such that a maximum or a near maximum electromagnetic absorption is achieved (which may, for example be defined as a zero (0) degree orientation) then a decrease in the electromagnetic absorption of the actuator may be achieved by rotating the actuator around a central longitudinal axis (e.g., axis 19 in FIG. 1) by 90 degrees from the first orientation. Processing then returns to decision block 700 where the pressure is again compared to the threshold pressure.

Alternatively, a decrease in the electromagnetic exposure/absorption of the actuator may be achieved by decreasing a transparency characteristic of the actuator. Any other suitable method of decreasing the electromagnetic exposure/absorption of the actuator that is presently known or later developed may be used.

When the pressure in the actuator is not greater than the threshold pressure, processing proceeds to block 704 where electromagnetic exposure/absorption in the actuator is increased. A pressure not greater than the higher threshold may represent a second activation limit (e.g., a lower activation limit of an automaton, for example). Processing then returns to decision block 700 where the pressure is again compared to the threshold pressure.

An increase in the electromagnetic exposure/absorption of the actuator may be achieved by at least rotating the actuator to the first orientation (e.g., 90 degrees from the second orientation), by increasing the transparency of the actuator, or any other suitable method of increasing the electromagnetic exposure/absorption of the actuator that is presently known or later developed.

Various embodiments of the concepts, systems, devices, structures and techniques sought to be protected are described herein with reference to the related drawings. As noted above, in embodiments, the concepts and features described herein may be embodied in a hydraulic-pneumatic actuator. Alternative embodiments can be devised without departing from the scope of the concepts, systems, devices, structures and techniques described herein.

It is noted that various connections and positional relationships (e.g., over, below, adjacent, etc.) are set forth between elements in the above description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description herein, terms such as “upper,” “lower,” “right,” “left,” “vertical,” “horizontal, “top,” “bottom,” (to name but a few examples) and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements. Such terms are sometimes referred to as directional or positional terms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. An actuator, comprising:
a vessel having a cavity and at least one opening and configured to hold a liquid;
a liquid disposed within the vessel, the liquid having a boiling point less than or equal to 100 degrees Celsius (C) and a heat of vaporization less than 2257 kJ/kg; and
a material disposed within the vessel and configured to absorb electromagnetic radiation and configured to vaporize the liquid in response to a temperature of the material substantially meeting or exceeding the heat of vaporization of the liquid.

2. The actuator of claim 1, wherein the material substantially meets or exceeds the heat of vaporization in response to untethered absorption of electromagnetic radiation.

3. The actuator of claim 1, wherein at least a portion of the vessel has a shape corresponding to one of:
a cylinder;
a sphere;
a cone;
a cube;
a prism; and
a pyramidal shape.

4. The actuator of claim 1, wherein the liquid is one of:
a non-cryogenic liquid; and
a cryogenic liquid.

5. The actuator of claim 1, wherein the material is configured to absorb electromagnetic radiation comprising at least one of:
infrared light;
laser light;
a magnetic field;
an electric field;
a radio wave;
a microwave;
ultraviolet light;
an X-ray; and
a gamma ray.

6. The actuator of claim 1, wherein the material comprises at least one of:
a nanomaterial;
a carbon nanotube;
MXene;
graphene; and
Vantablack.

7. The actuator of claim 1, wherein the actuator further comprises a heat sink coupled to the vessel.

8. The actuator of claim 1, wherein the actuator further comprises at least one of: at least one automaton and at least one second actuator attached to the at least one opening in the vessel, respectively, wherein the at least one automaton and the at least one second actuator are configured to exhibit at least one degree of motion upon vaporization of the liquid in the vessel.

9. The actuator of claim 8, wherein the at least one automaton is a bladder that exhibits a degree of motion comprising at least one of:
forward motion;
backward motion;
upward motion;
downward motion;
leftward motion;
rightward motion;
torsion motion;
bending motion;
elongation motion;
compression motion;
wrinkling motion; and
buckling motion.

10. The actuator of claim 1, wherein the actuator further comprises at least one shaft in the at least one opening of the vessel, respectively.

11. The actuator of claim 10, wherein the actuator further comprises at least one automaton attached to the at least one shaft in the vessel, respectively, wherein the automaton is configured to exhibit at least one degree of motion upon vaporization of the liquid in the vessel.

12. The actuator of claim 8, wherein the automaton is a bladder configured to exhibit a degree of motion comprising at least one of:
forward motion;
backward motion;
upward motion;
downward motion;
leftward motion;
rightward motion;
torsion motion;
bending motion;
elongation motion;
compression motion;
wrinkling motion; and
buckling motion.

13. The actuator of claim 1, wherein the actuator further comprises a rotator configured to rotate the vessel to control a temperature profile of the material and a pressure of vaporized liquid.

14. The actuator of claim 13, wherein the rotator is coupled to one of the vessel and a light source.

15. The actuator of claim 1, wherein the non-cryogenic liquid comprises at least methyl perfluoropropyl ether; and
the cryogenic liquid comprises at least one of:
liquified argon gas;
liquified oxygen gas;
liquified helium gas;
liquified hydrogen gas;
liquified nitrogen gas; and
liquified methane gas.

16. A method of actuation, comprising:
introducing a liquid into a vessel having at least one opening, wherein the liquid has a boiling point less than or equal to 100 degrees Celsius (C) and a heat of vaporization less than 2257 kJ/kg;
introducing a material into the vessel configured to absorb electromagnetic radiation and configured to vaporize the liquid in response to a temperature of the material substantially meeting or exceeding the heat of vaporization of the liquid due to untethered absorption of electromagnetic radiation; and
exposing the material to electromagnetic radiation.

17. The method of claim 16, wherein the material substantially meets or exceeds the heat of vaporization in response to untethered absorption of electromagnetic radiation.

18. The method of claim 17, further comprising:
determining if a pressure in the vessel exceeds a threshold;
in response to the pressure in the vessel exceeding the threshold, decreasing exposure/absorption to/of electromagnetic radiation and returning to determining the pressure in the vessel;
in response to the pressure in the vessel not exceeding the threshold, increasing the exposure/absorption to/of electromagnetic radiation and returning to determining the pressure in the vessel.

19. The method of claim 17, wherein the vessel has a shape to one of:
a cylinder;
a sphere;
a cone;
a cube;
a prism; and
a pyramidal shape.

20. The method of claim 17, wherein the liquid one of a non-cryogenic liquid and a cryogenic liquid.
